(19) United States
(12) Patent Application Publication
(10) Pub. No.: US 2025/0075742 A1
(43) Pub. Date: Mar. 6, 2025

(54) Rolling bearing assembly

(71) Applicants: AKTIEBOLAGET SKF, GOTEBORG (SE); SKF Australia Pty Ltd, Oakleigh (AU)

(72) Inventors: Lionel MARTIN, Kensington (AU); Franck LANDRIEVE, FONDETTES (FR)

(21) Appl. No.: 18/725,860

(22) PCT Filed: Dec. 22, 2022
(86) PCT No.: PCT/EP2022/087444

§ 371 Date: Jul. 1, 2024

(30) Foreign Application Priority Data
Jan. 10, 2022 (DE) 102022200165.6

(51) Int. Cl. F16C 41/00; F16C 19/38

(52) U.S. Cl. CPC F16C 41/00; F16C 19/38; F16C 2233/00

(57) ABSTRACT

A large rolling bearing assembly includes a rolling bearing and at least one displacement sensor module. The rolling bearing includes an inner ring, an outer ring, and a plurality of rolling elements between the inner ring and the outer ring, the inner ring is supported on a shaft, the outer ring is mounted in a housing, and the at least one displacement sensor module is configured to measure a radial position of the shaft in order to detect wear of the rolling bearing.

### CROSS-REFERENCE

This application is the U.S. National Stage of International Application No. PCT/EP2022/087444 filed on Dec. 22, 2022, which claims priority to German patent application no. 10 2022 200 165.6 filed on Jan. 10, 2022.

### TECHNOLOGICAL FIELD

The present disclosure is directed to a rolling bearing assembly, in particular a large rolling bearing assembly, having a displacement sensor.

### BACKGROUND

In technical systems, rolling bearings are often used, for example, for the supporting of shafts in a housing. Such rolling bearings wear in operation, which may lead to an increase in clearance within the rolling bearing, which in turn may lead a bearing failure. It is necessary to detect wear of the rolling bearing in order to possibly be able to plan a timely bearing replacement. Such wear may be detected by bearing clearance measurements, which are carried out manually by measuring the gap between the rolling elements and the raceways of the rolling bearings, for example using feeler gauges. However, this requires a removal of the housing cap or seals of the rolling bearing. Further, this in-situ inspection is time consuming and requires man-machine interaction, which is expensive and provides poor reliability as it is difficult to interpret the results.

### SUMMARY

It is therefore an aspect of the present disclosure to provide a reliable monitoring of wear of a rolling bearing, which is safer, less time consuming and more reliable.

The rolling bearing assembly may be a slewing bearing assembly, in particular a large rolling bearing assembly, which may be used, for example, in order to support a converter. Such converters are used inter alia in steelmaking or non-ferrous metal production.

The rolling bearing assembly includes a rolling bearing including an inner ring, an outer ring, and a plurality of rolling elements that are arranged between the inner ring and the outer ring. For example, the rolling bearing may be a double row spherical roller bearing. Other types of rolling bearings, such as, for example, ball bearings, are also possible. Here, the inner ring may be supported on a shaft. The outer ring may in turn be supported in a housing.

In order to monitor and to detect wear of the rolling bearing, the rolling bearing assembly includes at least one displacement sensor module, which is configured to measure a radial position of the shaft, in particular via an indirect measurement. The radial position of the shaft may be measured via a displacement of the shaft, for example via a (changing) distance between the shaft and the displacement sensor module or the housing. Wear of the rolling bearing, which is arranged between the shaft and the housing, causes the distance between the shaft and the housing to increase and thus also influences the radial position of the shaft, for example in relation to the displacement sensor module. As the displacement sensor module monitors the radial position of the shaft, wear of the rolling bearing may be detected by a change of the radial position.

The displacement sensor module may for example include a capacitive displacement sensor, proximity switch, eddy current sensor (eddy probe), or a path sensor. The displacement sensor module may include any sensors that are able to monitor a radial position of the shaft, a displacement of the shaft and/or a distance between the housing and the shaft and to detect a change of any one of these. A proximity switch may be implemented, for example, as an inductive, capacitive, or optical proximity switch.

In any case, such a displacement sensor reacts to an approach of the sensor to the shaft, as it is the case, for example, when the shaft tilts due to wear of the rolling bearing. If the radial position of the shaft changes, i.e., the distance between the housing and the shaft increases or decreases, such a displacement sensor emits a corresponding signal.

The radial position of the shaft may be measured by measuring a distance between the shaft and the housing, either directly or indirectly via elements being coupled to the shaft or the housing, e.g., intermediate rings or elements, seals etc., as will be described below.

In comparison to previous manual inspections of rolling bearing assemblies, i.e., inspections of the bearing clearance, it is possible to continuously monitor the rolling bearing assembly and thus the wear of the rolling bearing without the need for any manual interaction. Thus, an automatic, continuous, reliable and/or less expensive monitoring and inspection of a rolling bearing assembly is provided.

According to an embodiment, the displacement sensor module is integrated in the housing or the outer ring. In particular, the housing or the outer ring may include a radially extending opening into which the displacement sensor module may be pushed from outside. This has the advantage that a replacement of the displacement sensor module or a configuration/adjustment of the displacement sensor module is possible from outside without great effort.

With the previously used inspection, it was necessary to dismantle the rolling bearing assembly, for example, to open the housing in order to have access to the sensors. This is not necessary with the rolling bearing assembly proposed here, since the displacement sensor module may be pushed into the housing or the outer ring from outside.

Furthermore, this allows a simple exchange or configuration of the displacement sensor module from outside without the need to remove an additional part of the housing. It is also possible to retrofit existing rolling bearing assemblies with a displacement sensor module, since only one through-opening in the housing is required in order to insert the displacement sensor module into the rolling bearing assembly. Providing the displacement sensor as a module, i.e., a module that contains all sensor elements, simplifies the handling and the installation of the displacement sensor in comparison to individual elements.

According to a further embodiment, the displacement sensor module is arranged on a radial surface of the housing or of the outer ring adjacent to an axial end of the rolling bearing. The displacement sensor module may be installed, for example, on an inner radial surface of the housing or of the outer ring. Further, the displacement sensor module may measure the radial position or displacement of the shaft in relation to the housing or the outer ring, respectively.

According to a further embodiment, the displacement sensor module includes at least one sensor element and is arranged such that the at least one sensor element is arranged adjacent to the shaft. The displacement sensor module preferably extends from the housing or the outer ring toward the shaft. A sensor element may advantageously be arranged adjacent to the shaft, while the displacement sensor module is simultaneously pushed into the housing or the outer ring from outside. Due to a small distance between the shaft and the sensor element, a good recording and detection of the distance between shaft and housing is possible since the sensor element itself has only a small distance to the shaft, whereby the sensitivity is increased.

In a further embodiment, the at least one sensor element is arranged adjacent to an intermediate element being arranged on the shaft at an axial end of the rolling bearing. Preferably, the at least one sensor element is arranged to be adjacent to a radially outer surface of the intermediate element. Such an intermediate element may be for example a lock nut or clamping ring or labyrinth seal, which is arranged on the shaft next to the inner ring. In this case, the displacement sensor module may measure the radial position or displacement of the shaft not by monitoring the radial position of the shaft itself but by monitoring the radial position or displacement of the intermediate element being coupled to the shaft. Due to wear of the rolling bearing, the clearance between the rolling elements and the raceways, i.e., the rings, increases. This in turn leads to a change of the radial position of the shaft and hence also to a change of the radial position of the intermediate element being coupled to the shaft. Thus, according to this embodiment, the displacement sensor module is configured to perform an indirect measurement or monitoring of the radial position or displacement of the shaft by monitoring the radial position or displacement of the intermediate element, and thus of the shaft, for example in relation to the housing or the outer ring.

Instead of being arranged adjacent to an intermediate element being arranged on the shaft at an axial end of the rolling bearing, the at least one sensor element may be arranged adjacent to an intermediate element being arranged on the inner ring at an axial end of the rolling bearing. The intermediate element in this case may be a retaining ring or any other kind of intermediate component being arranged on the inner ring of the rolling bearing. The sensor element may preferably be arranged adjacent to a radially outer surface of the intermediate element. For example, the sensor module may be fixed to the housing or the outer ring and may monitor a position of the intermediate element, and thus of the shaft, in relation to the housing or the outer ring. Such an intermediate component provides the possibility to make an indirect measurement, in particular when there is limited space to fit a standard sensor module.

In order to enable an arrangement of the sensor element adjacent to the shaft, or the intermediate element, the displacement sensor module may include a tubular, radially extending receptacle which extends toward the shaft and is configured to receive sensor elements. The tubular receptacle is preferably pushed into an opening of the housing or of the outer ring. In this context a “tubular receptacle” may be understood to mean a round tubular receptacle, but also an angular tubular receptacle, for example, in a quadrangular shape.

The tubular receptacle may be attached to the housing or the outer ring. For example, the tubular receptacle may extend through the housing or the outer ring. The tubular receptacle may house all sensor elements of the displacement sensor module and/or any other components of the displacement sensor module, for example cables. The receptable may allow an easy positioning of the sensor adjacent to the shaft as the receptable may be made rigid and may thus be easily installed within the rolling bearing assembly. Further, the receptable may allow a connection from the sensor element(s) to the outside; for example, a cable connection may be guided to the outside in the tubular receptacle.

According to a further embodiment, the displacement sensor module includes a connecting element for connecting to an evaluation unit. The connecting element may be, for example, a plug, via which a connection to an external evaluation unit is possible. The connecting element may be connected, for example, via a cable to the sensor. The cable may be arranged in the above described receptable. The plug or the like may preferably be located outside the housing so that a simple connection to an evaluation unit is possible.

The displacement sensor module may include an adjusting device for adapting the distance between the displacement sensor module and the shaft. Such an adjusting device allows the same displacement sensor module to be used for different rolling bearing assemblies, since an adaptation to the specific distances and dimensions of the rolling bearing assembly is possible using the adjusting device. The adjusting device may be, for example, an adjusting screw or the like that may change the distance between the displacement sensor module and the shaft.

The displacement sensor module may be attached to the housing or the outer ring by attachment means. Such attachment means may include screw connections. In one embodiment, the adjusting device may also simultaneously serve as attachment means.

Instead of being arranged inside the housing or outer ring, the displacement sensor module may also be arranged radially outside a of a sealing unit which is arranged on at least one axial end of the rolling bearing. In this case, the sensor may also indirectly measure the radial position of the shaft as the sealing unit may be coupled to the shaft. This embodiment has the advantage that the displacement sensor module may easily be inserted into existing arrangements without making any changes as the sensor module is arranged outside of the housing, the rolling bearing, and the sealing unit. For example, the sensor module may be fixed to the housing and may monitor a changing position of the sealing unit in relation to the housing.

The rolling bearing assembly may also include two or more displacement sensor modules that are respectively arranged on an axial end of the rolling bearing. If two displacement sensor modules are used, in addition to the monitoring and detection of wear, a tilting of the shaft or a deflection of the shaft may also be detected. Since the two displacement sensor modules are arranged on both axial ends of the rolling bearing, different wear of the rolling bearing over the axial extension of the bearing may thus be detected. Such a changing wear may cause a tilting of the shaft and can be detected due to differently changing radial positions or displacements of the shaft on both axial ends of the rolling bearing. Further, a deflection of the shaft may be detected which also causes different radial positions of the shaft on both axial ends of the rolling bearing. The displacement sensor modules may be arranged as described above either directly adjacent to the shaft or adjacent to an intermediate element or arranged on a sealing unit, as long as one sensor module is arranged on each axial end of the rolling bearing.

Further preferred embodiments are defined in the dependent claims as well as in the description and the figures. Thereby, elements described or shown in combination with other elements may be present alone or in combination with other elements without departing from the scope of protection.

### BRIEF DESCRIPTION OF THE DRAWINGS

In the following, preferred embodiments of the invention are described in relation to the drawings, wherein the drawings are exemplarily only, and are not intended to limit the scope of protection. The scope of protection is defined by the accompanied claims, only.

FIG. 1 is a sectional view of a rolling bearing assembly including displacement sensor modules at four different positions.

FIG. 2 is a sectional view of a rolling bearing assembly including a displacement sensor module at a fifth position.

### DETAILED DESCRIPTION

In the following, identical or functionally equivalent elements are designated by the same reference numbers.

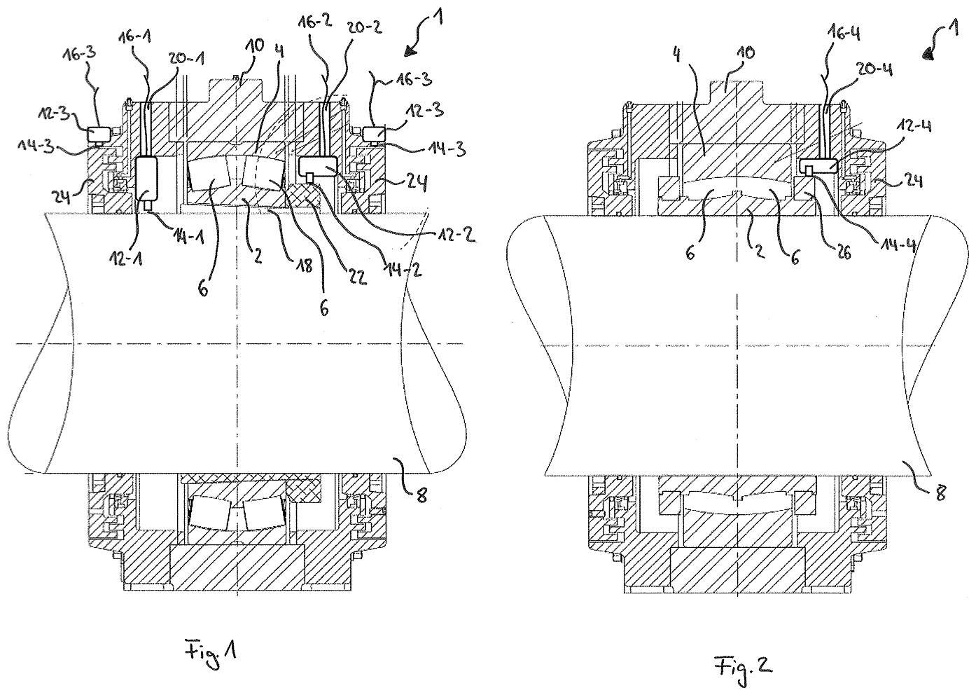

FIGS. 1 and 2 show a rolling bearing assembly 1, in particular a large rolling bearing assembly. The rolling bearing assembly 1 includes a solid rolling bearing including an inner ring 2 and an outer ring 4. Rolling elements 6, in this case spherical rollers, are arranged between the inner ring 2 and the outer ring 4.

In FIG. 1, the inner ring 2 is supported on a shaft 8 via an intermediate element 18. Alternatively, the inner ring 2 may be directly coupled to the shaft 8 as shown in FIG. 2. The outer ring 4 is supported in a housing 10. Alternatively, the housing 10 may form the outer ring 4. In order to detect wear of the rolling bearing, the rolling bearing assembly 1 includes one or more displacement sensor modules 12-1, 12-2, 12-3.

In FIG. 1, four different positions for the displacement sensor modules 12-1, 12-2, 12-3 are shown, as will be described in the following. The displacement sensor modules 12-1, 12-2, 12-3 may be used as alternatives but also in combination. For example, two of the sensor modules may be used, wherein each is arranged at one axial side of the rolling bearing.

Each variant of the displacement sensor modules 12-1, 12-2, 12-3 is configured to monitor a radial position of the shaft 8, in particular in relation to the housing 10. During the operating time of the rolling bearing assembly 1, the rolling bearing wears and causes an increasing distance between the raceways of the rings 2, 4 and the rolling elements 6 and thus an increasing distance between the housing 10 and the shaft 8 or at least a tilting of the shaft 8. By monitoring the radial position or displacement of the shaft 8, wear of the rolling bearing may be detected, and an exchange or a repair of the rolling bearing may be initiated in a timely manner.

As shown in FIG. 1, the displacement sensor module 12-1 is integrated into the housing 10. Alternatively, the displacement sensor module 12-1 may also be integrated in the outer ring 4. The displacement sensor module 12-1 is configured to measure a radial position of the shaft 8. This may be done by measuring a distance 14-1 between the displacement sensor module 12-1 and the shaft 8. For this, the displacement sensor module 12-1 is arranged adjacent to the shaft 8. This distance 14-1 is representative for the distance between the housing 10, to which the sensor module 12-1 is coupled (for example to a radial inner surface of the housing 10), and the shaft 8. When the radial position of the shaft 8 changes, also the distance between the sensor module 12-1 and the shaft 8 changes, both due to wear of the rolling bearing.

The displacement sensor module 12-1 may be connected to an evaluation unit or any other kind of processing unit (not shown). The connection may be realized via a cable 16-1. The cable 16-1 may be guided within an opening 20-1 through the housing 10. The displacement sensor module 12-1 may comprise a receptable which may be arranged within the opening 20-1 and which may house for example the cable 16-1.

Another variant of the displacement sensor module is illustrated by the sensor module 12-2. In this case, the sensor module 12-2 is also arranged on a radially inner side of the housing 10, wherein the cable 16-2 is guided through an opening 20-2. However, in contrast to the sensor module 12-1, the sensor module 12-2 does not directly measure the radial position of the shaft 8 but indirectly via an intermediate element 22. The intermediate element 22 is arranged on the shaft 8 or the element 18, respectively. The sensor module 12-2 measures a distance 14-2 between the sensor module 12-2 and the intermediate element 22.

Another possibility is realized by the displacement sensor modules 12-3. In this case, the two sensor modules 12-3 are arranged on radially outer surfaces of a sealing unit 24 and measure a distance 14-3 between the sealing unit 24 and the displacement sensor module 12-3. The sealing units 24 are arranged on each axial end of the rolling bearing and are in contact with the shaft 8. Thus, a position change of the shaft 8 results also in a position change of the sealing unit 24 which can then be detected by the displacement sensor modules 12-3. Particularly the sensor modules 12-3 may also be integrated into fully mounted rolling bearing assemblies 1, as the sensor modules 12-3 are attached to the outside surface of the sealing unit 24 and there is no need to make any changes to the rolling bearing assembly 1 or the rolling bearing or any other component.

If two displacement sensor modules are used, each on one axial side of the rolling bearing, in addition to a radial position of the shaft 8, a tilting of the shaft 8 or a deflection of the shaft 9 may also be detected. Since the wear of the rolling bearing may be different over the length of the rolling bearing, a tilting of the shaft 8 may result. Such a tilting of the shaft 8 may be recognized by different distances that are detected by the displacement sensor modules. For example, the sensor modules 12-3 may be used as pair of sensor modules on each axial side of the rolling bearing, but also the sensor module 12-1 in combination with 12-2 or 12-1 or 12-2 in combination with 12-3 may be used for providing a sensor module on each axial side of the bearing.

A further variant of the displacement sensor module is shown in FIG. 2 (showing a split bearing, as opposed to a standard (solid) bearing FIG. 1. In this case, the sensor module 12-4 is arranged adjacent to an intermediate element 26 (also called clamping ring) and on a radially inner surface of the housing 10, wherein a cable 16-4 may be guided through an opening 20-4 within the housing 10. The intermediate element 26 is arranged on a radial inner surface of the inner ring 2. Also in this case, the sensor module 12-4 may monitor a radial position of the shaft 8 as the intermediate element 26 changes its position together with a change of the shaft 8 and the inner ring 2.

Further, the displacement sensor module 12-4 of FIG. 2 may also be combined with the sensor modules 12-1, 12-2 and/or 12-3 of FIG. 1 as described above.

Using a displacement sensor module 12-1, 12-2, 12-3 and/or 12-4 as described above provides an easy and reliable possibility to monitor a position change of a shaft due to wear of a rolling bearing.

1-10. (canceled)

11. A large rolling bearing assembly comprising:
a rolling bearing; and
at least one displacement sensor module,
wherein the rolling bearing includes an inner ring, an outer ring, and a plurality of rolling elements between the inner ring and the outer ring,
wherein the inner ring is supported on a shaft,
wherein the outer ring is mounted in a housing, and
wherein the at least one displacement sensor module is configured to measure a radial position of the shaft in order to detect wear of the rolling bearing.

12. The rolling bearing assembly according to claim 11,
wherein the at least one displacement sensor module is integrated in the housing or is integrated in the outer ring.

13. The rolling bearing assembly according to claim 11,
wherein the at least one displacement sensor module is arranged on a radial surface of the housing or on a radial surface of the outer ring adjacent to an axial end of the rolling bearing.

14. The rolling bearing assembly according to claim 11,
wherein the housing or the outer ring includes a radially extending opening through which the at least one displacement sensor module is pushable from outside the housing or the outer ring.

15. The rolling bearing assembly according to claim 11,
wherein the at least one displacement sensor module includes at least one sensor element, and
wherein the at least one displacement sensor module is mounted so that the at least one sensor element is arranged adjacent to the shaft.

16. The rolling bearing assembly according to claim 11,
wherein the at least one displacement sensor module includes at least one sensor element, and
wherein the at least one displacement sensor module is mounted so that the at least one sensor element is arranged adjacent to an intermediate element mounted on the shaft at an axial end of the rolling bearing.

17. The rolling bearing assembly according to claim 11,
wherein the at least one displacement sensor module includes at least one sensor element, and
wherein the at least one displacement sensor module is mounted so that the at least one sensor element is arranged adjacent to an intermediate element mounted on the inner ring at an axial end of the rolling bearing.

18. The rolling bearing assembly according to claim 11,
wherein the rolling bearing assembly includes at least one sealing unit arranged on at least one axial end of the rolling bearing, and
wherein the at least one displacement sensor module is arranged radially outside of the sealing unit and configured to indirectly measure the radial position of the shaft.

19. The rolling bearing assembly according to claim 11,
wherein the at least one displacement sensor module comprises a first displacement sensor module and a second displacement sensor module,
wherein the first displacement sensor module is arranged at a first axial end of the rolling bearing, and
wherein the second displacement sensor module is arranged at a second axial end of the rolling bearing.

20. The rolling bearing assembly according to claim 11,
wherein the at least one displacement sensor module includes a tubular, radially extending receptacle extending toward the shaft for receiving at least one sensor element and/or at least one cable.

21. The rolling bearing assembly according to claim 11,
including a first seal assembly member supported by the housing and a second seal assembly member mounted on the shaft,
wherein the at least one displacement sensor module is located on the first seal assembly member and configured to measure a distance to the second seal assembly member or the at least one displacement sensor module is located on the second seal assembly member and configured to measure a distance to the first seal assembly member.

22. The rolling bearing assembly according to claim 21,
wherein the first seal assembly member and the second seal assembly member form a labyrinth seal.

23. The rolling bearing assembly according to claim 21,
wherein the at least one displacement sensor module is mounted on a radially outer surface of the first seal assembly member.

24. The rolling bearing assembly according to claim 21,
wherein the bearing is located in a space defined in part by the housing and the shaft, and wherein the at least one displacement sensor module is located outside the space.

25. The rolling bearing assembly according to claim 21,
wherein the bearing is located in a space defined by the housing and the shaft and at least one seal assembly, and
wherein the at least one displacement sensor module is located outside the space.
